(19) United States
(12) Patent Application Publication
(10) Pub. No.: US 2026/0202906 A1
(43) Pub. Date: Jul. 16, 2026

(54) System and Method for Synchronizing Real World and Virtual World Environments

(71) Applicant: Catalyst Entertainment Technology, Kitchener (CA)

(72) Inventors: Gregory Russell MATTINSON, Kitchener (CA); Philippe Ernest MESZAROS, Kitchener (CA); Patrick W. BELLIVEAU, Kitchener (CA)

(73) Assignee: Catalyst Entertainment Technology, Kitchener (CA)

(21) Appl. No.: 19/384,534

(22) Filed: Nov. 10, 2025

Related U.S. Application Data
(63) Continuation of application No. PCT/CA2024/050623, filed on May 8, 2024.
(60) Provisional application No. 63/501,184, filed on May 10, 2023.

(51) Int. Cl. G06F 3/01; G06T 19/00

(52) U.S. Cl. CPC G06F 3/011; G06F 3/016; G06T 19/003

(57) ABSTRACT

A system and method for synchronizing virtual and physical environments are provided. The method includes detecting an input to be applied in both a virtual environment and a physical environment; applying the input in the virtual environment; instructing the input to be applied in the physical environment; determining a deviation between the input applied in the physical environment; and applying a correction in the physical environment to synchronize the physical environment to the virtual environment.

### CROSS-REFERENCE TO RELATED APPLICATION(S)

This application is a Continuation of PCT Patent Application No. PCT/CA 2024/050623 filed on May 8, 2024; which claims priority to U.S. Provisional Ser. No. 63/501,184 , filed on May 7, 2023, the entire contents of which are incorporated herein by reference.

### TECHNICAL FIELD

The following generally relates to synchronizing real world and virtual world environments, for example between real world and virtual reality and/or augmented reality environments.

### BACKGROUND

Humans experience reality via a variety of senses that all inform the brain. In its simplest form, the body relies on the nervous system and visual cues to understand what is happening and the limbic system layers context onto what is happening (e.g., good, bad, excited, scared, etc).

Virtual Reality (VR) has been around for decades but is currently experiencing unprecedented success in the market as VR headsets become less expensive and more mainstream. For example, previous norms in the industry, such as that headsets are expensive, that a highly capable computer is required, or that the headset must be connected via cable to such a computer, are being broken. This lowers the barrier to entry both from a cost perspective and a learning curve perspective (i.e., one can place the headset on their head and be guided as to how to operate the headset).

These headsets allow users to experience new worlds through thrilling visual renders but, as discussed above, humans experience reality with more than just vision, and the nervous system plays a large role, which still presents challenges. For example, side effects of VR experiences can still include nausea since what the user is seeing does not align with their other senses, leading the body to believe it has been poisoned and triggering such nausea.

The use of VR experiences typically also requires synchronization between real life and the virtual world, which may require knowing a relationship between a user's physical sensations and the visual representation of that sensation in the virtual world.

### SUMMARY

To overcome challenges with synchronizing physical sensations in the real world and visual representations in the virtual world, an inverted approach is provided in which visual changes in the virtual world are smoothly applied and the physical environment synchronized to the virtual world, e.g., such that corresponding changes requested in the physical world adhere to a newly requested position, orientation or other movement. This leverages that the visual sensory system is more finely tuned than the nervous system that detects physical motion.

In one aspect, there is provided a method of synchronizing virtual and physical environments, comprising: detecting an input to be applied in both a virtual environment and a physical environment; applying the input in the virtual environment; instructing the input to be applied in the physical environment; determining a deviation between the input applied in the physical environment; and applying a correction in the physical environment to synchronize the physical environment to the virtual environment.

In an example embodiment, the correction is applied at one or more subsequent inputs to be applied to the physical environment.

In an example embodiment, at least a portion of the correction is applied at the next input to be applied to the physical environment.

In an example embodiment, the correction is applied in multiple portions over a plurality of subsequent inputs.

In an example embodiment, the input is associated with movement, the method further comprising detecting that an object in the virtual environment being synchronized is stationary, and pausing the correction for a period of time.

In an example embodiment, the period of time is correlated to resumption of movement in the virtual environment.

In an example embodiment, the input comprises at least one relative movement of an object.

In an example embodiment, the movement comprises a change in position of the object.

In an example embodiment, the movement comprises a change in orientation of the object.

In an example embodiment, the input applied in the physical environment is responsive to a position and velocity request provided by the virtual environment to a motion platform.

In an example embodiment, the method further comprises determining an estimate of a current location of the motion platform in the physical environment, and applying the correction based at least in part on the estimate of current location and a requested position.

In an example embodiment, the correction is applied by modifying a physical movement according to a weight based on a delta between the requested position and the current location.

In an example embodiment, the virtual environment comprises virtual reality.

In an example embodiment, the virtual environment comprises an augmented reality.

In an example embodiment, the correction is applied to a plurality of subsequent movements over time according to a smoothing function.

In another aspect, there is provided a computer readable medium comprising computer executable instructions that, when executed by a processor of a computing device, cause the computing device to perform the method.

In another aspect, there is provided a computing device configured to synchronize virtual and physical environments, the computing device comprising a processor and memory, the memory comprising computer executable instructions that, when executed by the processor, cause the computing device to perform the method.

### BRIEF DESCRIPTION OF THE DRAWINGS

Embodiments will now be described with reference to the appended drawings wherein:

FIG. 1A is a schematic diagram illustrating an existing approach to synchronizing between physical and virtual environments by synchronizing the virtual world to the physical environment.

FIG. 1B is a schematic diagram illustrating an inverted control paradigm in which synchronization between physical and virtual environments is effected by synchronizing the physical environment to the virtual environment.

FIGS. 2A, 2B, and 2C illustrate a series of operations that synchronize a physical environment to a virtual environment.

FIG. 3 is a schematic block diagram of a combined virtual and physical system.

FIG. 4 illustrates an example of a motion platform configured as a steerable vehicle or racing car.

FIG. 5 illustrates a multi-player experience in which two users are either using the same physical motion platform or different virtual platforms rendered together virtually.

FIG. 6 is a schematic block diagram of an architecture for the motion platform.

FIG. 7 is a block diagram illustrating a motion platform having swappable sub-systems.

FIG. 8 is a flowchart illustrating operations that may be performed in synchronizing a physical environment to a virtual environment.

### DETAILED DESCRIPTION

To address challenges with providing combined virtual and physical world experiences, a VR-enhanced motion platform can be used, for example, as described in co-pending PCT Patent Application No. PCT/CA2023/050052 filed on Jan. 19, 2023, the contents of which are incorporated herein by reference. In this example implementation, a local experience venue such as an arena may be provided, in which to use such motion platforms (e.g., ride, explore, watch), and a wider experiential content and interactivity ecosystem with which to deliver VR-enhanced physical experiences provides an experience that breaks one-to-one mappings between the virtual and physical worlds. The systems and methods can be used to disrupt the single experience platform by combining VR, which lacks real G-forces, and haptic feedback, with a motion platform capable of real speeds and G-forces felt by the user's body, in contrast to simulators. The ecosystem and environments capable of being deployed and utilized according to the following systems and methods can address traditional problems with location-based entertainment venues, as well as further enabling virtually limitless experiences that VR headsets can deliver, which can include bidirectional experiences that involve global audience participation in events. The ecosystem can enable multiple arenas to play/race/experience the same event in the virtual environment, from different physical locations. Moreover, the ecosystem can further integrate audience members that can view and/or participate with the arenas from another location such as from their home.

In this way, the same VR headset and motion platform can remain constant while the content can continually change to meet varying consumer demands both in real-time and over time. Given the appropriate visuals, the motion platform can be used to simulate experiences such as space exploration vehicles, race cars, boats, motorcycles, go-karts, military vehicles, etc. The motion platform can also be configured to interface with the human body in a way that simulates other experiences through haptic feedback mechanisms, for example, ziplining, skydiving, paintballing, etc.

Such a system requires synchronization between the physical (real-world) environment and the virtual environment (e.g., VR world). This synchronization includes determining and updating the relationship(s) between the user's physical sensations and the virtual representation of the sensations in the virtual environment.

Prior attempts to address challenges with such synchronization may apply techniques to synchronize the virtual environment to the physical environment, which can result in an unsmooth virtual experience, e.g., by having to accurately identify the object's position in the physical space and then render it in VR. However, it is found that this means the virtual experience may only ever be as good as the system's knowledge of the physical location. Such a paradigm can create a host of issues such as sensor sampling rate (e.g., how many times does it generate data per second), how accurate is the data, compute latency (e.g., data was not good enough on one sensor thus sensor fusion was required), etc. For example, with sensor fusion, there can be noise in the incoming data which causes the object (e.g., vehicle or other motion platform) in VR to either jump around slightly or have delayed movement, which can in turn break the immersion. While compensation can be attempted using techniques such as data smoothing, other issues can arise, e.g., where sharp vehicle motions were ignored (smoothed) and again the immersion was broken. Other solutions to synchronize according to this paradigm could include the use of additional and/or more expensive sensors using more complicated algorithms. However, added complexity typically comes with added cost, which can be prohibitive.

To address the challenges with the current paradigm, the system described herein inverts the paradigm by rendering changes in the virtual environment which are used to apply corresponding movements in the physical environment to therefore render changes in the virtual environment smoothly and avoid challenges with trying to synchronize the virtual environment to the physical environment. This recognizes that the user's eyes are considered the most finely tuned sensory instrument on the human body. As such, trying to correct data where the user will notice it the most creates an immediate challenge, as described above. However, the user's nervous system understands general motion but is not considered sophisticated enough to discern specific angles. For example, if asked to walk a certain distance in front of the user at a certain angle, to successfully and repeatedly achieve such a precise repositioning may require following a guideline such as a line applied to the underlying surface rather than relying on the nervous system.

In an inverted control approach to synchronization, the following describes a system that prioritizes rendering movements or other changes in the virtual environment and synchronizes the physical environment to the virtual environment with course corrections as needed, to adhere to the newly requested position. This recognizes that it can be difficult if not impossible to have perfect knowledge of the physical location and/or have this be in perfect synchronization with the physical object, but the physical object can do its best to track to the virtual world request without taking away too much from the overall combined experience.

For example, a request may be made in the virtual environment (e.g., by an input to a VR system) to physically move an object such as a motion platform in the physical environment a distance of 15 feet ahead at a 90 degree angle. However, due to an imperfect knowledge of the positioning of the motion platform, the platform actually only travels to 14 feet at 90 degrees. Rather than perform complicated location tracking to ensure this discrepancy does not occur, the next time motion is requested, the platform instructions can include a course correction that aims to get the motion platform back on track. For example, if the new motion request was another 15 feet at 90 degrees the actual instructions could be 16 feet at 90 degrees to include a course correction along with the current request.

Given that a user's nervous system is not finely tuned, the user would likely not be aware of the applied course correction. Moreover, if a large course correction is required, this can be smoothed over time by applying multiple course corrections to subsequent movements as needed to align with the virtual rendering. Additionally, by only applying course corrections while the user is in motion, the system can avoid triggering the nervous system without corresponding visuals to match such a correction. For example, a course correction would be avoided when the user sees that they are stationary in a VR world so as to avoid breaking the immersion.

To apply an inverted control to combined physical and virtual environments, a continuous function can be applied to compare the real world location and velocity to a virtual location and velocity. If deviations between the real and virtual environments are detected, a course correction process can be applied to offset or eliminate the difference between the two in one or more subsequent operations while physical movement is taking place. That is, the offset(s) can be applied to synchronize the physical environment to the virtual environment as needed, while maintaining a smooth rendering in the virtual environment per the input(s) received.

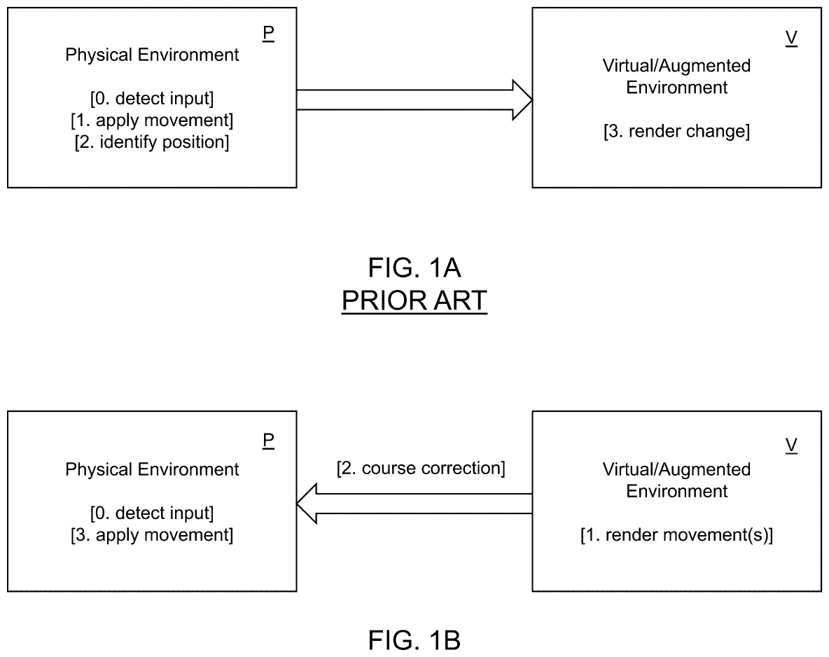

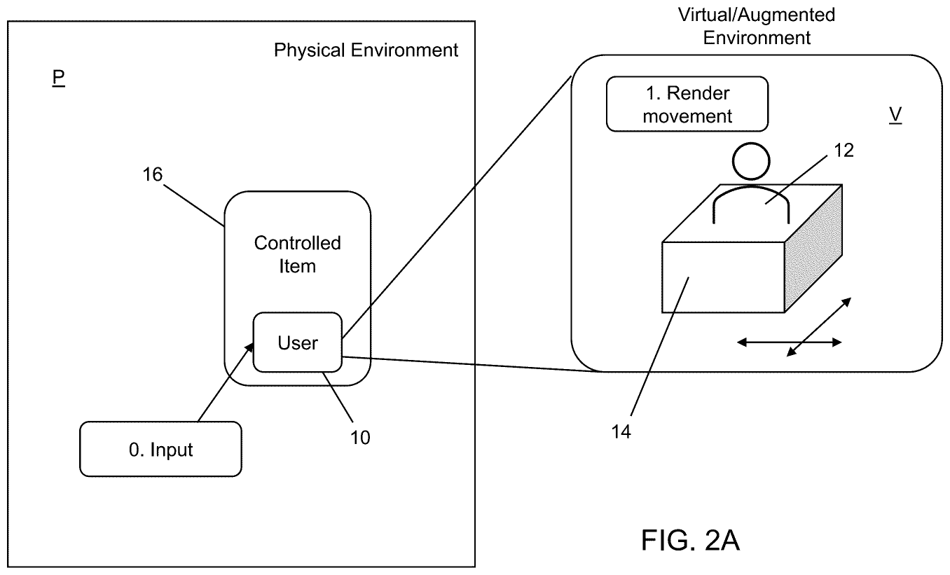

Referring now to the figures, FIG. 1A illustrates a traditional control paradigm applied to a combined or otherwise interacting physical environment (P) and virtual environment (V). In this example, at step 0 an input is detected in the physical environment P (e.g., an input to move or steer an object to some extent). At step 1, a movement is applied to an object that is being used by a user. At step 2,the position of the object is identified, in order to synchronize the movement in the virtual rendering in the virtual environment V. The adjustments (i.e., movements in this example) based on the identified location are then requested in the virtual environment V such that a corresponding change is rendered in the virtual environment V at step 3. As indicated above, this approach requires an accurate detection and identification at step 2 in order to synchronize the rendering of the corresponding movement at step 3 in the virtual environment, which tracks with the physical movement. Inaccurate or low quality data can thus lead to visual renderings that do not track well with the physical movements thus providing incorrect visual cues to the user, to which the user is more sensitive.

The inverted control paradigm is illustrated in FIG. 1B, in which an input is detected in the physical environment P at step 0 (for example, a steering or acceleration command), and is smoothly rendered in the virtual environment V at step 1 with the physical environment synchronized thereto. The requested movement is also applied to the physical environment P at step 3 which may include a course correction sent at step 2, based on a prior movement that was out-of-sync with the virtual rendering that was prioritized under the inverted control paradigm.

As noted above, humans are more sensitive to visual inconsistencies and jitter than physical ones and acceleration is felt more than speed. Hence, it considered more important to have the visual experience smooth and consistent, allowing some inconsistencies in the physical experience. In the inverted control paradigm, the user's inputs map directly to virtual world actions, like a regular video game (VR or not). The system can also take those inputs and apply them to the physical motion platform or other object being moved in the physical environment P. Typically, the two systems do not respond exactly the same. For example, the physical motion platform may have acceleration limitations where the virtual world does not. For instance, if the angle is incorrect by 1 degree, and one travels 10 meters, the user would end up 0.17 meters away from where they should be. After time, all the small errors between the two systems add up and the physical motion platform becomes out of sync with the virtual environment V. From a user's experience, this is acceptable, since they feel what they see. However, if multiple motion platforms are in the same space, or the space has physical constraints (e.g., walls and posts, not an infinite canvas), then eventually these small errors create new problems.

To correct for this, the experience (e.g., game) sends velocity requests (X, Y, and Angular) as well as position requests (X, Y, and Yaw angle). The physical motion platform primarily uses the velocity requests to perform its movements. It also has an estimate of its current location in the real world. Any delta between this estimate and the requested position is also applied as physical movement, but with a much smaller weight so that the physical position gradually realigns with where the virtual world is expecting it to be without introducing a large incorrect velocity which would confuse the user. The weight between the two requests can be dynamically calculated based on many factors, including the requested velocity of the motion platform. For example, if the game says “Don't move, and be at (5, 3) with 0 degrees” and we're actually several meters from that location, the physical motion platform would not move. Conversely, if the experience sends the same position information but a non-zero velocity is included, then the physical motion platform will move in the direction requested with a small compensation factor to make the positions align again.

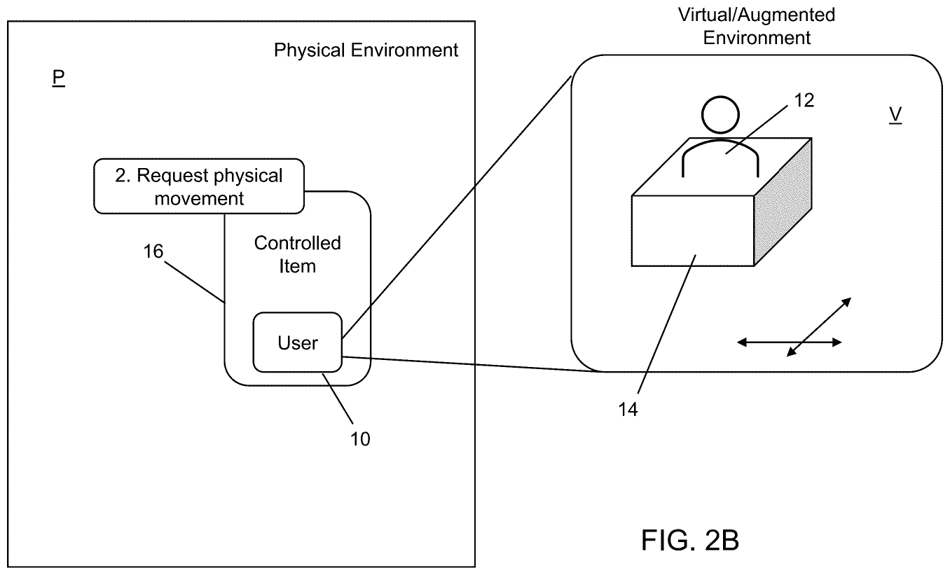

FIGS. 2A-2C illustrate the inverted control paradigm pictorially. Referring first to FIG. 2A, based on an input at step 0, the corresponding movement is rendered with full accuracy at step 1 in the virtual environment V. As shown in FIG. 2B, a physical movement is also requested at step 2 in order to make a corresponding movement in the physical environment P. This request may include a course correction based on a previous movement's deviation from the requested movement and, at FIG. 2C, the physical movement is applied. Any inaccuracies between the movement applied at step 3 and that rendered virtually at step 1 can be determined by tracking the physical location of the controlled item 16 and user 10 in the physical environment, compared to the item 14 and user 12 in the virtual environment V.

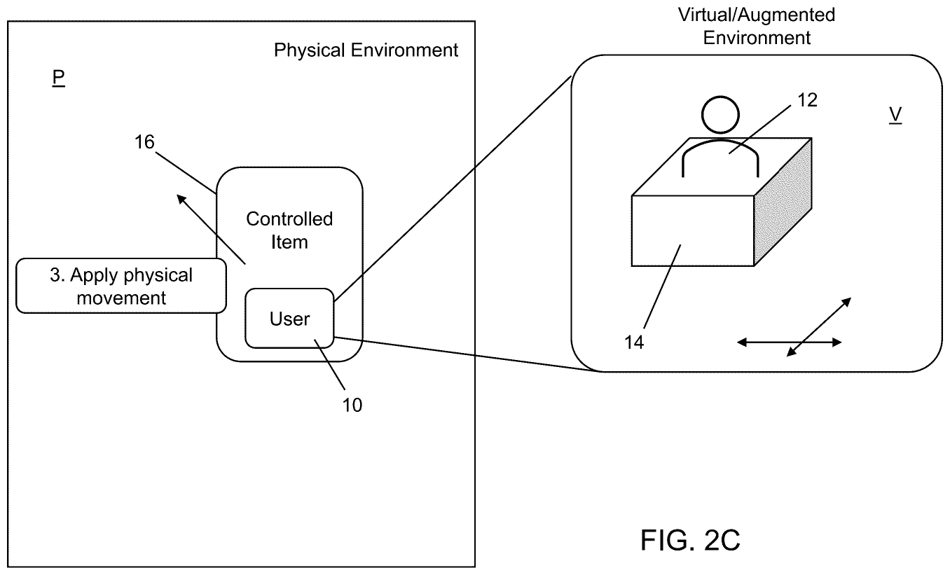

FIG. 3 illustrates an example of a system that includes both physical and virtual components. In this example, the controlled item 16, such as a motion platform, is used in conjunction with a VR/AR system 20, with a VR or AR headset 52 or other wearable device to render a visual output, such by providing a VR or AR environment. The system 20 includes a processor 22 and VR/AR content 24, e.g., a game or other experience. The system 20 may also include one or more communication interfaces 26 to interact with a network 28, e.g., to access cloud-based content or to interact with audiences or remote users. The system 20 can include one or more communication links 34 with the controlled item 16, hereinafter referred to as a motion platform 16 for ease of illustration. However, it will be appreciated that the principles apply to any item in the physical world that is controlled in conjunction with a virtual rendering. The motion platform 16 can include one or more onboard inputs 30, e.g., steering, acceleration, shooting, etc. as well as one or more external inputs 32. The external inputs may be applied via the motion platform 16 or directly to the system 20.

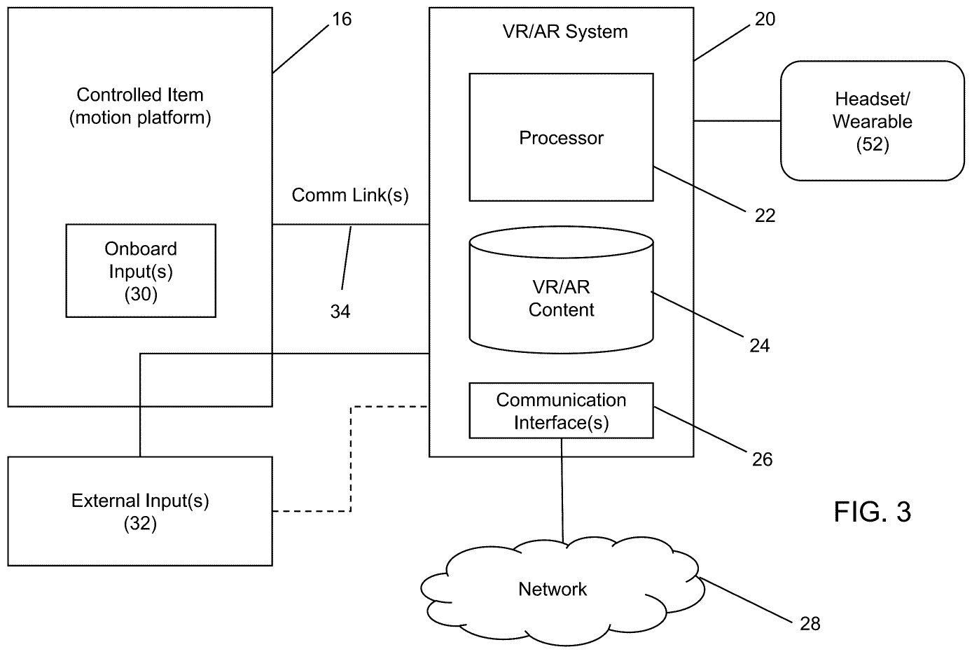

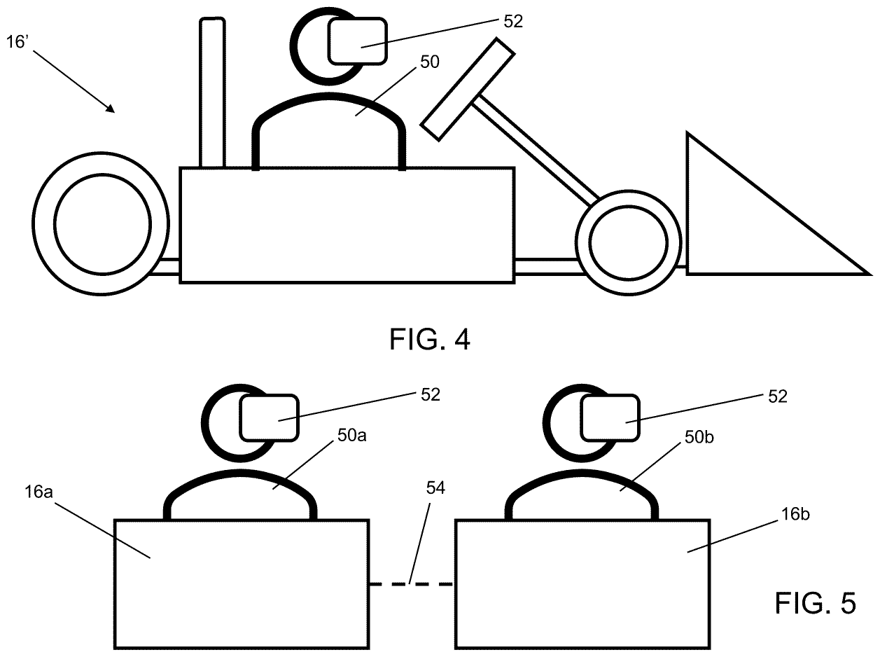

FIG. 4 illustrates an example of a motion platform 16 that is configured as a go-kart or racing vehicle in which a user 50 equipped with a VR headset 52 can ride the vehicle 16′ within the arena 14 while experiencing the track, environment, and other racers in the virtual world. It can be appreciated that the form shown in FIG. 4 is purely illustrative and can be adapted to differently sized vehicles that accommodate different sub-systems such as drive systems (e.g., number of motion units or wheels), seating configurations, steering wheel/yoke configurations, and onboard space for batteries and control systems. FIG. 5 illustrates a pair of users 50 in a pair of coupled motion platforms 16a, 16b, with the coupling 54 between users being either physical (e.g., a two-seater motion platform 16a/16b) or virtual (e.g., a virtually rendered dual seat vehicle pieced from separate motion platforms 16a, 16b).

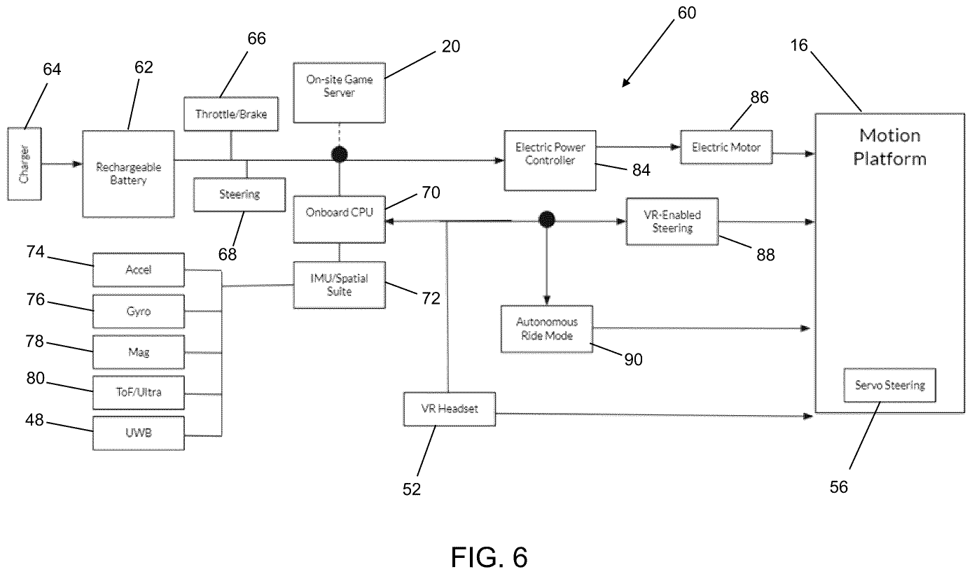

An example architecture for the motion platform 16 is shown in FIG. 6. In this example, the motion platform 16 includes a servo steering mechanism 56, which can provide manual control, autonomous control, or both. The servo steering mechanism 56 can be adapted for or replaced with any steering mechanism 56 suitable for the steering type uses, e.g., swerve, omni-directional, etc. as discussed below. The motion platform 16 is powered by a rechargeable battery 62 (or battery pack) that can be recharged using a suitable charger 64. The battery 62 provides power to a throttle/brake control 66, a steering control 68 and permits connectivity with the local (on-site) arena server 20. The battery 62 also powers an onboard CPU 70 and an electric power controller 84. The electric power controller 84 is used to drive one or more electric motors 86 to provide motive power to the motion platform 16.

The onboard CPU 70 (which could also or instead be in the VR headset 52) is coupled to an inertial measurement unit (IMU) 72 that has access to various sensors, for example, an accelerometer 74, gyroscope 76, magnetometer 78, a time of flight (ToF) camera 80, an UWB tag 48. The onboard CPU 70 also connects to both a VR-enabled steering module 88 and an autonomous ride mode module 90. The onboard CPU 70 can also connect to the VR headset 52 to coordinate experience data (e.g., game data) that affects both the physical experience (via the motion platform 16) and the virtual experience (within the VR headset 52).

Various optional features of the overall system will now be provided. Where appropriate, the motion platform 16 can be or include a vehicle. The vehicle in this case is the actual physical vehicle (e.g., kart) that the players sit in. The vehicle can have one or more seats, some controls, one or more motors for propulsion, power supply, safety systems, a vehicle control system and a VR headset 52 for each passenger.

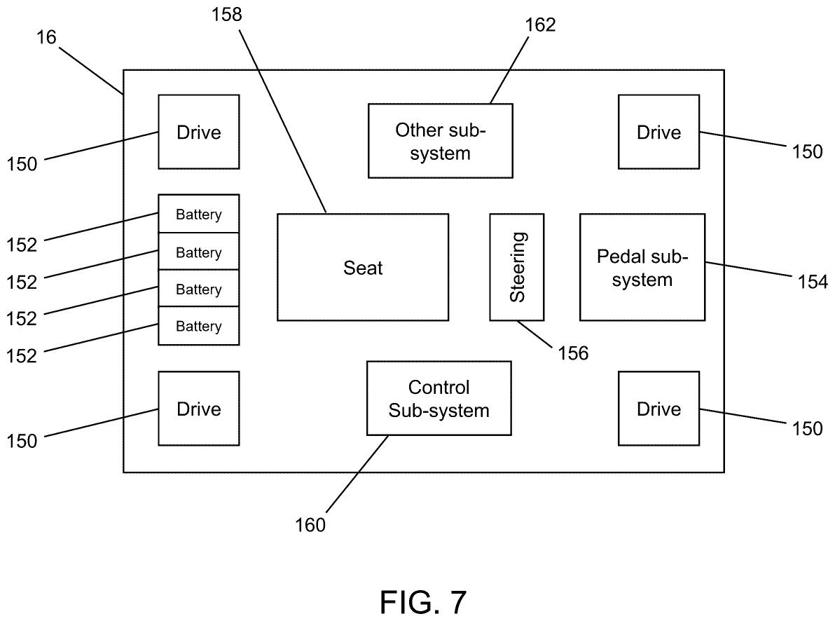

The motion platform 16 can be run by hot-swappable rechargeable batteries 62, e.g., lithium batteries or more traditional lead-acid batteries that are typically used in go-karts. The vehicle can be designed to have space for additional batteries 62 to allow for an expansion of equipment and computing power required to drive the VR experience. The motion platform 16 can also be configured to include a number of individual swappable sub-systems to remove complexity and reduce the time associated with repairing motion platforms 16 on-site. FIG. 7 illustrates a schematic example of a motion platform 16 with a number of such swappable sub-systems. Examples shown include, without limitation, modular drive sub-systems 150, which can be removed individually from the motion platform 16. In this way, if a tire or wheel fails, the motion platform 16 can be put back online quickly without requiring a skilled technician or mechanic, by having extra drive sub-systems 150 available on site for easy swapping. Similarly, hot-swappable battery units 152 are shown (four in this example for illustrative purposes), which can be removed quickly on-site as noted above. Other sub-systems that are possible due to the “everything-by-wire” design, include those systems that translate a physical input (e.g., from a user) to an electrical signal that is fed into the VCS or other system. For example, a pedal sub-system 154 can be modularized to allow for repairs as well as different swappable configurations to be made on-site, e.g., to switch from single pedal to multi-pedal motion platforms 16. Similarly, a steering sub-system 156 allows the motion platforms 16 to utilize different steering systems (e.g., aircraft versus race car) while at the same time allowing for failure replacements in real-time. A seat system 158 can also be swappable to allow for different sizes and control options to be changed or failed seats to be replaced. A control sub-system 160 is also shown, which illustrates that other modularized portions of the overall architecture can be made swappable for ease of changeover and repair. Various other sub-systems 162 can also be modularized as needed, depending on the type of experience, application, motion platform 16, user, arena 14, etc. It can be appreciated that any consumable or wearable part or sub-system can be modularized as illustrated in FIG. 7. Moreover, these sub-systems can be serialized and tracked at the arena 14 and within a wider inventory system such that the consumed or broken sub-systems are sent off-site for repair. Such serialization and tracking can also be used to track the number of faults in different configurations, settings, or venues, to enable other actions to be taken, e.g., to correct employee behaviors or detect defects. Automated tracking can also enable sites to automatically order new parts as they are consumed and detected on-site.

Returning to FIG. 6, in an illustrative example, for propulsion, the propulsion system can use computer-controlled brushless DC motors (BLDC) as the electric motors 86 and the vehicle can utilize one, two or four motors. For example, a single-motor rear-wheel drive can be provided with a steering servo that controls the direction of the two front wheels. This is also similar to how most traditional go-karts work. Having two independently powered wheels can provide more flexibility, easier control, and the ability to do things like turning in place. Having four independently powered wheels provides even greater control, e.g., swerve-type control, possibly using multi-or omni-directional wheels each using one or multiple motors. Additional wheels (e.g., for a total of 6 or 8 wheels) can also be implemented. In the two-and four-wheeled cases hub motors (similar full-scale electric cars) could also be utilized. The physical throttle/braking system 66 can also be computer controlled in this example architecture.

The steering mechanism 68 can include force feedback so the user knows when the system 10 is steering for them, an accelerator, a brake and some sort of switch or lever for changing directions (i.e., forward and reverse). These elements can be provided by the throttle/brake module 66 in connection with the steering module 68.

In this example, the motion platform 16 receives commands from the onboard CPU 70, such as steering/speed limits to prevent collisions, specific steering/speed settings when auto driving, limits set to 0 when game is stopped (kart initializes in this state), if no limits, and no specific settings, local inputs (pedals and steering wheel) control movement; if no input for 2 seconds, assume arena server 20 has crashed, and set all limits to 0 (i.e., stop kart). For example, if no inputs are registered and shared from the onboard CPU 70 to the arena server 20, the arena server 20 can command all onboard CPUs 70 to shutdown as it assumes a fault. No knowledge of the location of other motion platforms 16, and no complicated logic would therefore be required to avoid collisions, since this is handled centrally.

An example vehicle design can use a steering wheel, an accelerator pedal, a brake pedal and a fwd/rev switch (e.g., mounted on the steering wheel). This can vary based on the experience (e.g., game), arena 14, motion platform 16, etc., and can be made modular (e.g., swap the steering wheel for a joystick or a flight yoke or a rudder control lever). These variations can be made without impacting the software, since the same four basic inputs are the same (steering, acceleration, brake, direction). In addition, there can be various switches and buttons. For example, there might be a switch for turning the (virtual) lights on and off, a button for the (virtual) horn, controls for the radio (which plays spatialized audio in the virtual environment), etc. For safety reasons, a “deadman's chair” and seat belt lock can also be implemented.

The on-board vehicle control system (i.e., the complete system of controllers/microcontrollers on-board the motion platform 16 and separate from the headset 52) takes input from the user controls and uses it to drive the propulsion system (i.e., drive-by-wire). The main controller can, by way of example only, be an ESP32 which communicates with other system components using, for example, Canbus or I²C. A separate motor control processor (e.g., ESP32 or ATmega328) that uses one pulse-width modulation (PWM) output to control the steering servo 56 and another PWM output to control the electronic power controller 84 that drives the electric motor 86. By default, the vehicle control system can read the steering input and apply it to the steering servo 56, and read the (accelerator, brake, direction) inputs and apply them to the electric motor 86. The brake can be made to take precedence over the accelerator, so if the brake is pressed the accelerator input is set to zero. The brake input can also be applied to the mechanical brake once engine braking becomes ineffective. Additionally, the ESP32 (or equivalent controller) can receive messages from the global server 22 to partially or completely override the player's control. The ESP32 (or equivalent controller) can also send status messages to the global server 22. The ESP32 (or equivalent controller) can also read the IMU 72 to determine which direction the vehicle is facing (i.e., yaw) but can also be capable of sensing pitch and roll (which may be useful in case of unforeseen circumstances).

The vehicle control system ecosystem can have a removable EEPROM containing parameters such as vehicle number (but see more below), motor parameters, friction coefficient, hardware version, WiFi connection details, central server IP address, logs, etc.

The steering, accelerator and brake inputs are connected to the ADC on another ATmega328, and the direction switch is connected to a digital input. Other binary inputs (lights, horn, etc.) can also be connected to the ATmega328 In one example, the ATmega328 sends all these inputs to the ESP32 over I²C.

A tracking system 47 (e.g., time of flight sensor, lidar, etc.), including either front and back mounted sensors or a rotating 360 degree sensor mounted on a mast can also be used as discussed above.

The ESP32 (or equivalent controller) can also run a small web server that displays the vehicle state and allows forcing of outputs. It can also allow changing of parameters and activation of ground lights to identify the vehicle.

Several independent safety systems can be used that are designed to keep the players as safe as possible. The arena server 20 can send a message to a vehicle control system (VCS) to stop the vehicle as quickly as possible in a safe manner. The VCS as described herein may include any one or more components used in controlling the MP 16, e.g., the components and system design shown in FIG. 9. The arena server 20 can also send “heartbeat” messages at regular intervals. If the VCS does not receive a message from the arena server 20 within a certain interval, it stops the vehicle quickly. There can also be a sensor in each seat that detects when a player has left the vehicle. If this sensor is triggered, the VCS stops the vehicle quickly. There can also be a sensor in each player's safety harness. If the player removes their harness, the VCS stops the vehicle quickly. Temperature, current and voltage-level sensors can be used in the battery 62 such that if the values are out of range, the VCS cuts power immediately. Similarly, if the lidar system 47 detects anything getting too close, the VCS stops the vehicle quickly. A separate “Sentinel” (e.g., another ATmega328) can also be used to communicate with the other components over I²C. If it doesn't hear from all of them on a regular basis, it completely cuts power to the vehicle after applying the brakes and notifying the arena server 20.

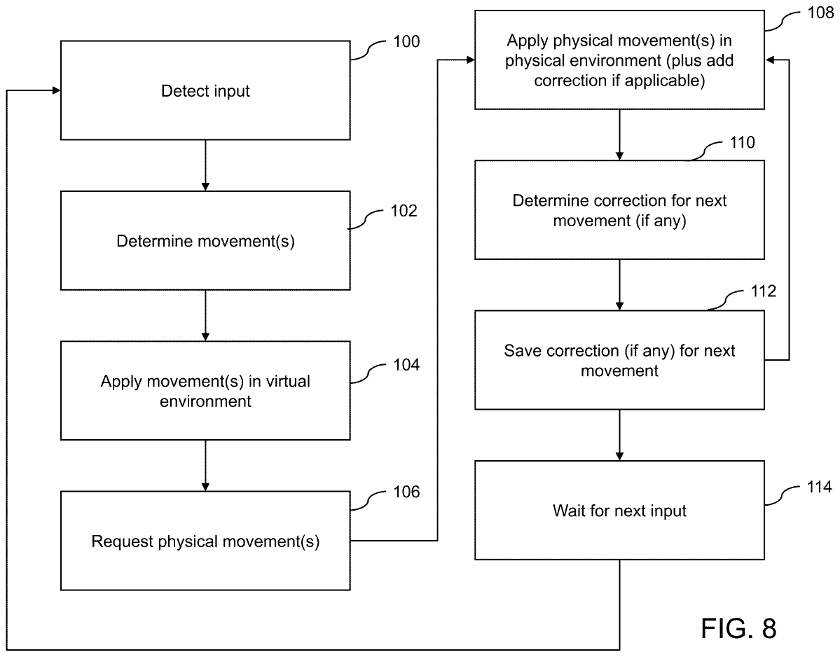

Referring now to FIG. 8, a flowchart is provided illustrating operations that may be performed in applying an inverted control paradigm to a combined physical and virtual experience. At step 100, an input is detected on or by the motion platform 16, e.g., to accelerate and steer the motion platform 16 in a particular direction. At step 102, the requested movements is/are determined and applied in the virtual environment at step 104. The movements rendered in the virtual environment may be made as accurate as possible to the input(s) such that the user sees what they are expecting to see. The system 20 also requests the corresponding physical movements at step 106, without the need to apply any position determination or level of accuracy in the physical movements applied at step 108. However, this may include a course correction applied from a previous input. Once the physical movement is made, a course correction function can be applied at step 110 to determine any deviations between the movement rendered in the virtual environment and that applied in the physical environment. The deviation can be saved as a course correction at step 112 to be applied at the next input at step 114. The course correction, if large, can be split into multiple corrections to be applied over more than one subsequent movement, to smooth out the correction.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the devices shown herein, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A method of synchronizing virtual and physical environments, comprising:
detecting an input to be applied in both a virtual environment and a physical environment;
applying the input in the virtual environment;
instructing the input to be applied in the physical environment;
determining a deviation between the input applied in the physical environment; and
applying a correction in the physical environment to synchronize the physical environment to the virtual environment.

2. The method of claim 1, wherein the correction is applied at one or more subsequent inputs to be applied to the physical environment.

3. The method of claim 2, wherein at least a portion of the correction is applied at the next input to be applied to the physical environment.

4. The method of claim 2, wherein the correction is applied in multiple portions over a plurality of subsequent inputs.

5. The method of claim 1, wherein the input is associated with movement, the method further comprising detecting that an object in the virtual environment being synchronized is stationary, and pausing the correction for a period of time.

6. The method of claim 5, wherein the period of time is correlated to resumption of movement in the virtual environment.

7. The method of claim 1, wherein the input comprises at least one relative movement of an object.

8. The method of claim 7, wherein the movement comprises a change in position of the object.

9. The method of claim 1, wherein the movement comprises a change in orientation of the object.

10. The method of claim 1, wherein the input applied in the physical environment is responsive to a position and velocity request provided by the virtual environment to a motion platform.

11. The method of claim 10, further comprising determining an estimate of a current location of the motion platform in the physical environment, and applying the correction based at least in part on the estimate of current location and a requested position.

12. The method of claim 11, wherein the correction is applied by modifying a physical movement according to a weight based on a delta between the requested position and the current location.

13. The method of claim 1, wherein the virtual environment comprises virtual reality.

14. The method of claim 1, wherein the virtual environment comprises an augmented reality.

15. The method of claim 1, wherein the correction is applied to a plurality of subsequent movements over time according to a smoothing function.

16. A computer readable medium comprising computer executable instructions that, when executed by a processor of a computing device, cause the computing device to:
detect an input to be applied in both a virtual environment and a physical environment;
apply the input in the virtual environment;
instruct the input to be applied in the physical environment;
determine a deviation between the input applied in the physical environment; and
apply a correction in the physical environment to synchronize the physical environment to the virtual environment.

17. A computing device configured to synchronize virtual and physical environments, the computing device comprising a processor and memory, the memory comprising computer executable instructions that, when executed by the processor, cause the computing device to:
detect an input to be applied in both a virtual environment and a physical environment;
apply the input in the virtual environment;
instruct the input to be applied in the physical environment;
determine a deviation between the input applied in the physical environment; and
apply a correction in the physical environment to synchronize the physical environment to the virtual environment.
